(19) United States
(12) Patent Application Publication
(10) Pub. No.: US 2026/0243309 A1
(43) Pub. Date: Aug. 20, 2026

(54) Shaft-hub connection arrangement between a metallic shaft and a hub made of plastic

(71) Applicant: Hilti Aktiengesellschaft, Schaan (LI)

(72) Inventors: Steffen MUCHA, Dirlewang (DE); Daniel SELTMANN, Türkheim (DE)

(21) Appl. No.: 19/142,930

(22) PCT Filed: Jan. 3, 2024
(86) PCT No.: PCT/EP2024/050065

§ 371 Date: Jun. 24, 2025

(30) Foreign Application Priority Data
Jan. 17, 2023 (EP) 23152033.9

(51) Int. Cl. F16D 1/104; F16D 1/10; F16D 3/06

(52) U.S. Cl. CPC F16D 1/104; F16D 3/06; F16D 2001/103

(57) ABSTRACT

A shaft-hub connection arrangement for transmitting torques between a metallic shaft (1) and a plastic hub (2) connected in a positive-locking manner thereto, wherein the shaft (1) is provided with at least one longitudinal groove (3), concave in cross-section, at least in the connecting region, and in that the hub (2) is provided correspondingly with a folding lever that extend inwards from the inner wall (6) and come to rest in a positive-locking manner in groove flank regions (5a, 5b) of the longitudinal groove (3) on both sides.

### DESCRIPTION

The present invention relates to a shaft-hub connection arrangement for transmitting torques between a metallic shaft and a plastic hub connected in a positive-locking manner thereto. The invention also relates to an electric hand tool with a drive unit that is connected in particular to a gear unit via such a shaft-hub connection arrangement.

### BACKGROUND

The field of application of the invention extends primarily to electric motor-driven machine tools—in particular, hand tools—such as drills, hammer drills, or chisel hammers, whose rotationally driven components—in particular, an electric motor drive unit—are to be connected by a shaft-hub connection to a downstream component—for example, a gear unit for transmission and/or conversion into the rotational drive energy. In the context of the present application, hubs can be designed as gear wheels, plug-in sleeves, or other parts of a structural element arranged in the drive train.

### SUMMARY OF THE INVENTION

With the technical trend towards increasingly lightweight construction, hubs made of a plastic material are often used. In contrast, shafts are usually made of a metallic material. In the context of such pairing of such materials, it must be avoided that wear of the connecting point occurs with an increasing torque to be transmitted via the shaft-hub connection. For this reason, a positive-locking connection, which is of interest here, is usually selected for such special pairing of materials.

The generally known prior art includes positive-locking shaft-hub connection arrangements with which, for example, a spline connection, also called a keyway connection, is used. This is a multiple-driver connection, wherein the torque is transmitted by the tooth flanks. For this purpose, the shaft is externally toothed, and the hub interacting with it is internally toothed. This type of spline connection requires a high degree of manufacturing accuracy so that all tooth flanks are involved in the transmission in the context of a slight elastic deformation.

Also generally known are shaft-hub connection arrangements with which a shaft with a round cross-section interacts with a corresponding bore on the part of the hub, wherein the positive-locking fit is produced via at least one connecting means that at least partially penetrates the two components transversely to the axial direction—for example, a set screw or a bolt. Furthermore, feather keys and the like are also used as connecting means for such single-driver connections, although these are suitable for use in conjunction with plastic hubs only to a limited extent due to the locally concentrated torque transmission point.

DE 77 40 014 U1 shows a generic shaft-hub connection arrangement between a metallic shaft and a hub made of plastic that is connected in a positive-locking manner thereto. Disclosed is a plastic hub that can be plugged onto a shaft—in particular, a hub of a plastic fan wheel that can be plugged onto a motor shaft of an axial fan—and has a metal part that is incorporated close to the shaft bore before being plugged on and that can be brought into driving connection with the shaft via a fastening element, wherein at least one U-shaped sheet-metal tab with a leg opening directed radially towards the shaft is inserted into the plastic hub, into which tab a corresponding drive pin connected to the shaft engages for positive-locking connection when the plastic hub is plugged on. However, for this technical solution, several auxiliary components are required to provide the connection.

It is [an object of the present invention to further improve a shaft-hub connection arrangement of the generic type in such a way that a reliable, positive-locking rotary connection can be produced without separate components.

The present invention provides a haft-hub connection arrangement for transmitting torques between a metallic shaft (1) and a plastic hub (2) connected in a positive-locking manner thereto, characterized in that the shaft (1) is provided with at least one longitudinal groove (3), concave in cross-section, at least in the connecting region, and in that the hub (2) is provided correspondingly with folding lever means that extend inwards from the inner wall (6) and come to rest in a positive-locking manner in groove flank regions (5a, 5b) of the longitudinal groove (3) on both sides.

The invention includes the technical teaching that the shaft is provided with at least one longitudinal groove, concave in cross-section, at least in the connecting region, and that the hub is provided correspondingly with folding lever means that extend inwards—preferably, predominantly radially inwards—from the inner wall, which folding lever means in the assembled state come to rest in a positive-locking manner in groove flank regions of the longitudinal groove on both sides.

The advantage of the solution according to the invention lies in particular in the fact that a direct positive-locking connection for assembling a metal shaft in a plastic hub is made possible without the need for further metal components that provide a rotational connection. The connection according to the invention also makes it possible to compensate for any movement play between the plastic hub and the metal shaft that normally occurs as a result of the load. This is because the resilient properties of the plastic material, in conjunction with the geometric design of the longitudinal groove in the form of a concave curvature, mean that the folding lever means formed on the plastic shaft have a play-compensating effect. The functional integration of the folding lever means according to the invention as a positive-locking fastening component on the plastic hub means that additional individual parts are not required.

According to a preferred embodiment of the invention, the folding lever means comprise at least two lever legs extending from the same starting point of the inner wall, and extending inwardly therefrom in a V-shape. The distal ends of the lever legs come to rest in the flank region of the concave longitudinal groove, creating a stable, positive-locking shaft-hub connection in both directions of rotation. In an alternative embodiment, the folding lever means can also have lever legs extending from different starting points of the inner wall.

According to a measure that further improves the invention, locking tongues facing one another are pivotably formed in the distal end region of the lever legs. Such locking tongues can also be pivotably connected to one another with a film hinge at the abutting distal ends, in order to ensure the desired connection security. Apart from this, in the locked position, the locking tongues also nestle against the groove base region of the concave longitudinal groove or are supported against the groove base region of the concave longitudinal groove, in order, in this position, to secure the locked position of the lever legs. Thus, the lever legs equipped with the locking tongues interact with one another and with the concave longitudinal groove of the shaft to form a kind of bistable toggle lever mechanism.

In an alternative design, a bistable element, which is connected to the two lever legs, can be provided. The bistable element is used in particular instead of the two locking tongues. The bistable element can be moved from an outwardly curved base position in the direction of an inwardly curved spread position. In the spread position, the bistable element assumes a self-locking position.

Preferably, the shaft should be provided with several concave longitudinal grooves distributed over the entire circumference, resulting in a star profile in cross-section. Corresponding to this, one or more folding lever means can be provided on the inside wall of the hub, each of which interacts with one of the concave longitudinal grooves.

For additional or alternative locking of the lever legs, according to a further optional measure, the intermediate space formed by this can be provided with an insertion element, in order to hold the lever legs in the locked target position. Pins with a round or triangular profile, for example, are suitable as insertion elements.

In the shaft-hub connection arrangement according to the invention, the envelope diameter of the shaft is matched to the hub diameter in such a way that there is at least a partial clearance fit along the axial connecting section of both components. This allows a slight radial play movement of the component connection, without affecting torque transmission. This is because the torque transmission is effected via the folding lever means.

### BRIEF DESCRIPTION OF THE DRAWINGS

Further measures improving the invention are explained in more detail below together with the description of a preferred exemplary embodiment of the invention with reference to the figures. In the drawings:

FIG. 1 shows a schematic cross-section through the shaft-hub connection arrangement in the mounted position of the shaft with the hub, and

FIG. 2 shows a schematic cross-section of the shaft-hub connection arrangement in the locked position after assembly according to FIG. 1.

### DETAILED DESCRIPTION

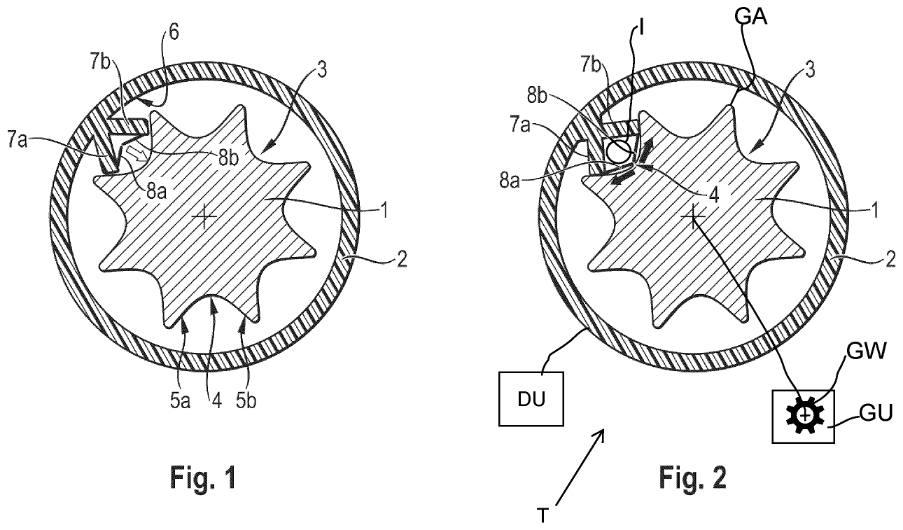

According to FIG. 1, the schematically shown shaft-hub connection arrangement for transmitting torques consists of a metallic shaft 1 on the one hand, and a hub 2 made of plastic on the other—which is only partially shown here.

The shaft 1 is provided with several concave longitudinal grooves 3 arranged adjacent to one another along its circumference. The longitudinal grooves 3 describe a pitch circle in cross-section. Around the deepest point, each longitudinal groove 3 comprises a groove base region 4 and groove flank regions 5a and 5b bordering it on both sides. In this exemplary embodiment, all three regions 4, 5a, and 5b occupy approximately the same curved section of the groove cross-section.

Corresponding to the longitudinal groove 3, folding lever means are formed on the inner wall 6 of the hub 2. In this exemplary embodiment, the folding lever means, which also consist of the plastic material of the hub 2, are formed from two lever legs 7a and 7b that extend in a V-shape from the same starting point on the inner wall 6 and extend inwards. Locking tongues 8a or 8b facing one another are formed in the distal end region of the respective lever legs 7a and 7b. They are moved in the direction indicated by the arrow to lock the positive-locking connection after assembly.

According to FIG. 2, the locking tongues 8a and 8b of the lever legs 7a and 7b nestle against the groove base region 4 of the longitudinal groove 3 in the locked position and thereby spread the lever legs 7a and 7b in the direction indicated by the arrow. This causes the lever legs 7a and 7b to be pressed apart in the manner of a toggle lever clamping mechanism, such that they are pressed against the longitudinal groove 3 with the distal end region. Such locked position can be additionally secured by an insertion element—shown solely schematically as I—in the intermediate space formed by the lever legs 7a and 7b.

It can be seen that there is a gap GA between the inner wall 6 of the hub 2 and the enveloping circle diameter of the shaft 1, which gap causes a clearance fit between the two components along the axial connecting section, but which is transformed into an interference fit by the locked folding lever means. In this exemplary embodiment, the folding lever means assigned to it are illustrated only on a single longitudinal groove 3. However, such folding lever means are provided in a manner distributed over the entire circumference for several of the longitudinal grooves 3. Also shown solely schematically in FIG. 2 is a drive unit DU and gear wheel GW of a gear unit GU.

The invention is not limited to the preferred exemplary embodiment described above. On the contrary, modifications thereof are also conceivable, which are encompassed by the scope of protection of the following claims. For example, it is also possible to provide only some of the longitudinal grooves arranged along the circumference with assigned folding lever means for a positive-locking connection. Accordingly, it is not necessary to equip the entire circumference of the shaft with the concave longitudinal grooves, such that a star profile is formed. The number of concave longitudinal grooves of the shaft which interact with positive-locking connecting means and have folding lever means on the hub side depends primarily upon the maximum torque to be transmitted.

### LIST OF REFERENCE SIGNS

1 Shaft
2 Hub
3 Longitudinal groove
4 Groove base region
5a, 5b Groove flank region
6 Inner wall
7a, 7b Lever leg
8a, 8b Locking tongue

What is claimed is:

1-11. (canceled)

12: A shaft-hub connection arrangement for transmitting torques between a metallic shaft and a plastic hub connected in a positive-locking manner thereto, the shaft-hub connection arrangement comprising:
at least one longitudinal groove, concave in cross-section, of the shaft in a connecting region; and
folding lever means in the connecting region and extending inwards from an inner wall of the hub and resting in a positive-locking manner in groove flank regions of the longitudinal groove on both sides.

13: The shaft-hub connection arrangement as recited in claim 11 wherein the folding lever means comprise at least two lever legs extending from a same starting point on the inner wall and extending inwardly therefrom in a V-shape.

14: The shaft-hub connection arrangement as recited in claim 11 further comprising locking tongues facing one another are pivotably formed in the distal end region of the lever legs.

15: The shaft-hub connection arrangement as recited in claim 14 wherein the locking tongues nestle against a groove base region of the longitudinal groove in a locked position.

16: The shaft-hub connection arrangement as recited in claim 11 wherein the at least one longitudinal groove includes several concave longitudinal grooves arranged adjacent to one another over the circumference of the shaft so as to define a star profile.

17: The shaft-hub connection arrangement as recited in claim 13 further comprising an insert for locking the lever legs, the insert arranged in an intermediate space formed by the lever legs.

18: The shaft-hub connection arrangement as recited in claim 11 wherein a clearance fit exists axially between the inner wall of the hub and an enveloping circle diameter of the shaft.

19: The shaft-hub connection arrangement as recited in claim 11 wherein the shaft is designed as a gear shaft.

20: The shaft-hub connection arrangement as recited in claim 11 wherein the hub is a component of a gear wheel.

21: The shaft-hub connection arrangement as recited in claim 20 wherein the gear wheel is designed as a toothed wheel, a friction wheel, or a belt pulley.

22: An electric hand tool comprising: a drive unit connected to a gear unit via a shaft-hub connection arrangement according to one of the preceding claims.
